(19) United States
(12) Patent Application Publication
(10) Pub. No.: US 2005/0196011 A1
(43) Pub. Date: Sep. 8, 2005

(54) Structure of rising part of coil

(76) Inventors: Yoshihide Goto, Sagae-shi (JP); Hirotaka Sato, Sagae-shi (JP)

Correspondence Address: LADAS & PARRY LLP, 224 SOUTH MICHIGAN AVENUE, SUITE 1600, CHICAGO, IL, 60604, US

(21) Appl. No.: 10/901,492

(22) Filed: Jul. 28, 2004

(30) Foreign Application Priority Data
Mar. 3, 2004 (JP) P2004-58695

(51) Int. Cl. H04R 25/00

(52) U.S. Cl. 381/410; 381/400; 381/407

(57) ABSTRACT

An electric wire in a rising part, which is obtained by covering a conductor whose sectional shape is a square with an insulating film, is formed in a curve so that the inside of the curve is along the circumference of a circle having a radius “r” until the electric wire risen from the coil in which the electric wire is wound is turned in a desired direction. The radius “r” of the circle has a length, which is equal to or larger than ½ of one side R of the square as the sectional shape of the conductor of the electric wire.

### BACKGROUND OF THE INVENTION

1. Field of the Invention

The present invention relates to a coil around which an electric wire is wound, and particularly, to a structure of a rising part of a coil using an electric wire obtained by covering a conductor having a square or rectangular cross-section with an insulating film. More particularly, the invention relates to a structure of a rising part of a coil for preventing a damage of an electric wire, which occurs in the rising part for rising the electric wire from the coil to turn the electric wire to a desired direction.

2. Related Art

FIG. 8 is a front view showing an example of a coil disclosed in Japanese Patent No. 3,236,469. The disclosure of the corresponding U.S. Pat. No. 5,937,076 is hereby incorporated by reference in its entirety. As shown in FIG. 8, a bobbin 13 formed in a cylindrical shape by a paper material or a paper material impregnated with a resin is provided. A coil 11 such as a voice coil obtained by winding an electric wire 14 made of a conductor (round wire or rectangular wire) covered with an insulating film around the outer peripheral surface of the bobbin 13 is provided. A first coil 11a and a second coil 11b construct the coil 11 shown in FIG. 8. The coils 11a and 11b are disposed at an interval of dimension “d” in the axial direction of the bobbin 13. The coils 11a and 11b are wound around the axis of the bobbin 13 in the directions opposite to each other.

In the coil, in most of the cases, the electric wire 14 is wound in a cylindrical shape, and after that, the electric wire 14 must be risen from a coil part (coil 11a), turned in a desired direction, for example, in the almost same direction as the axial direction of the cylinder of the cylindrical coil 11 in FIG. 8, and led as a lead wire. Consequently, the electric wire 14 is bent in the direction almost orthogonal (90°) to the circumferential direction of the coil and is risen in a rising part 12.

However, when the electric wire 14 is risen in the direction almost perpendicular to the circumferential direction of the coil 11 (the axial direction of the cylinder of the cylindrical coil 11) as shown in FIG. 8, the insulating film and the conductor of the electric wire 14 at the rising part 12 are damaged, and broken down by heat generation of the rising part 12 by electricity flowing in the coil.

In the case of an electric wire in which the conductor has a circular sectional shape (round wire), since the shape is not directional, a damage to the insulating film is relatively small. However, an electric wire in which the sectional shape of a conductor is a square or rectangle has corners as shown in FIGS. 4 and 5, and consequently, a problem arises such that the damage mentioned above easily occurs.

### SUMMARY OF THE INVENTION

An object of the invention is to provide a structure of a rising part of a coil using an electric wire obtained by covering a conductor whose sectional shape is a square or rectangle with an insulating film, capable of preventing the rising part from being damaged.

We have keenly studied to solve the above problems, and as a result, obtained the following findings.

Without bending an electric wire from a coil at 90° or a predetermined angle of bending, by bending the electric wire in a curve shape and turning the electric wire to a desired direction, a damage in the rising part by heat generated by electricity flowing in the coil can be prevented.

The rising part is formed in a curve whose inside is along the circumference of a circle having the radius “r”, and the length of the radius “r” of the circle is specified so as to hold a predetermined relation with length of one side of a square or rectangle as the sectional shape of a conductor, thereby enabling to properly prevent the damage to occur.

The invention has been achieved on the basis of the above findings.

The invention according to claim 1 relates to a structure of a rising part of a coil,
wherein at the time of rising an electric wire obtained by covering a conductor whose sectional shape is a square with an insulating film from a coil in which the electric wire is wound, and turning the electric wire in a desired direction, said electric wire is formed in a curve so that the inside of the curve is along the circumference of a circle having a radius “r” until said electric wire risen from said coil is turned in said desired direction, and said radius “r” has a length which is equal to or larger than ½ of one side of the square as the sectional shape of said conductor.

The invention according to claim 2 relates to a structure of a rising part of a coil,
wherein at the time of rising an electric wire obtained by covering a conductor whose sectional shape is a rectangle with an insulating film from a coil in which the electric wire is wound, and turning the electric wire in a desired direction, said conductor has a rectangular shape in cross section, having a length which is longer than the length of another side orthogonal to said one side and is equal to or less than 1.5 times of the length of another side, said electric wire is formed in a curve so that the inside of the curve is along the circumference of a circle having a radius “r” until said electric wire risen from said coil is turned in said desired direction, and said radius “r” has a length which is equal to or larger than ½ of said another side of the rectangle as the sectional shape of said conductor.

By forming an electric wire obtained by covering a conductor whose sectional shape is a square or rectangle with an insulating film in a curve so that the inside of the curve is along the circumference of a circle having a radius “r” until the electric wire is turned to a desired direction without angling the rising part which rises from a coil using the electric wire, and maintaining the relation between the radius “r” and length R of one side of the square as the sectional shape of the conductor or length R of other side of the rectangle (shorter side) at r≧(½)·R, a damage on the rising part by heat generation by electricity flowing in the coil can be prevented.

### BRIEF DESCRIPTION OF THE DRAWINGS

FIG. 1 is a front view of a coil according to an embodiment of the invention;

FIG. 2 is a side view of the coil according to the embodiment of the invention;

FIG. 3 is a front view showing a rising part of the coil according to the embodiment of the invention;

FIG. 4 is a cross sectional view showing a square sectional shape of a conductor according to the embodiment of the invention;

FIG. 5 is a cross sectional view showing a rectangular sectional shape of the conductor according to the embodiment of the invention;

FIG. 6 is a circuit diagram showing a tester in examples of the invention;

FIG. 7 is a conceptual diagram of a coil part in the examples of the invention; and

FIG. 8 is a front view of a conventional coil.

### DESCRIPTION OF PREFERRED EMBODIMENTS

An embodiment of the invention will be described hereinbelow with reference to the drawings.

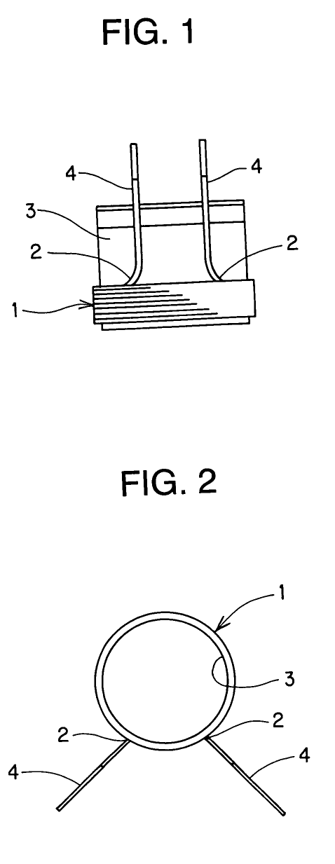

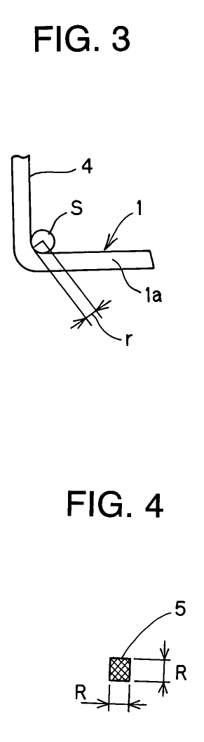

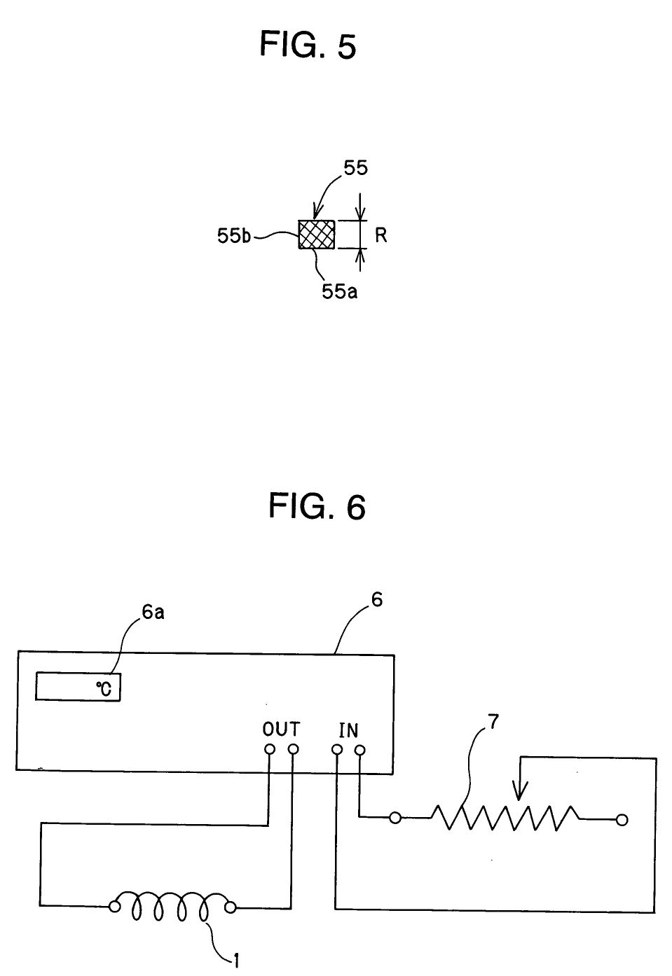

FIGS. 1 to 5 are diagrams showing the embodiment of the invention. FIG. 1 is a front view of a coil, FIG. 2 is a side view thereof, FIG. 3 is a front view showing a rising part, FIG. 4 is a cross sectional view showing a square sectional shape of a conductor, and FIG. 5 is a cross sectional view showing a rectangular sectional shape.

The invention relates to the structure of a rising part of a coil using an electric wire 4 obtained by covering a conductor 5 having a square shape in cross section as shown in FIG. 4, or a rectangular conductor 55 as shown in FIG. 5 with an insulating film (not shown).

As shown in FIG. 1, a bobbin 3 formed in a cylindrical shape is provided, and an electric wire 4 is wound around the outer peripheral surface of the bobbin 3, thereby forming a coil 1. In each of rising parts 2 and 2, the electric wire 4 wound in the cylindrical coil 1 is turned from a coil part 1a in the direction almost similar to the axial direction of the cylinder of the cylindrical coil 1, and is risen as a lead wire. The rising direction of the electric wire 4 varies according to coils.

The electric wire 4 risen from the coil 1 is formed in a curve whose inside is along the circumference of a circle S as shown in FIG. 3 until it is turned to the rising direction. The radius “r” of the circle S is equal to or larger than ½ of the length R of one side of a square (refer to FIG. 4) as the sectional shape of the conductor 5, that is, r≧(½)·R. When the length of the radius “r” is less than ½ of the length R of one side of the square, heat is generated by electricity flowing in the coil, and a trouble such that the electric wire 4 of the rising part 2 is broken down occurs. Although the upper limit of the length of the radius “r” is not particularly specified, it may be determined according to the kind of the coil, restrictions in designing, and the like.

According to the invention, even in the case where the sectional shape of a conductor of an electric wire is a rectangle, when one side 55a of a rectangle (refer to FIG. 5) as the sectional shape of the conductor 55 lies in the range longer than the length of another side 55b orthogonal to the side 55a to 1.5 times as long as the length of another side 55b, effects similar to those of the case where the section of the conductor is a square shape are obtained. In this case, the length of a shorter side of the rectangle, that is, the other side 55b is set as R, and the length of “r” is calculated.

In the case where there is the possibility that an electric wire is risen with the radius of r≧(½)·R according to the invention, and then becomes r<(½)·R, the electric wire 4 may be adhered by an adhesive or the like, and fixed in the rising part 2 in order to hold the risen form as it is. Alternately, the electric wire 4 may be pressed, and fixed by a reinforcement member such as paper, plastic, or glass.

### EXAMPLES

The invention will be described more specifically by using examples.

A coil having a rising part in the range of the invention, and a coil having a rising part which is out of the range of the invention, were prepared. An acceleration test was conducted on the coils to examine durability. Specifically, the electric wire 4 obtained by covering the conductor 5 having a square sectional shape and whose one side R is 0.16 mm with an insulating film is wound around a bobbin 9, and the resultant was disposed between external magnetic poles (plates) 10. The rising part was formed in a curve shape so that the shape of the inside of the curve of the electric wire 4 is along the circumference of the circle S as shown in FIG. 3, and the coil was prepared so that the length of the radius “r” of the circle S with respect to one side R of the square (see FIG. 4) as the sectional shape of the conductor 5 satisfies r=(½)·R which is in the range of the invention (hereinbelow, called “test piece 1 of the invention”). Similarly, a coil whose rising part satisfies r=(⅔)·R (called “test piece 2 of the invention”), a coil whose rising part satisfies r=( 1/1)·R (called “test piece 3 of the invention”), and a coil whose rising part satisfies r=( 2/1)·R (called “test piece 4 of the invention”) were prepared.

For comparison, a coil in which the length of the radius “r” is r=(⅖)·R which is out of the range of the invention (called “test piece 1 for comparison”) was prepared.

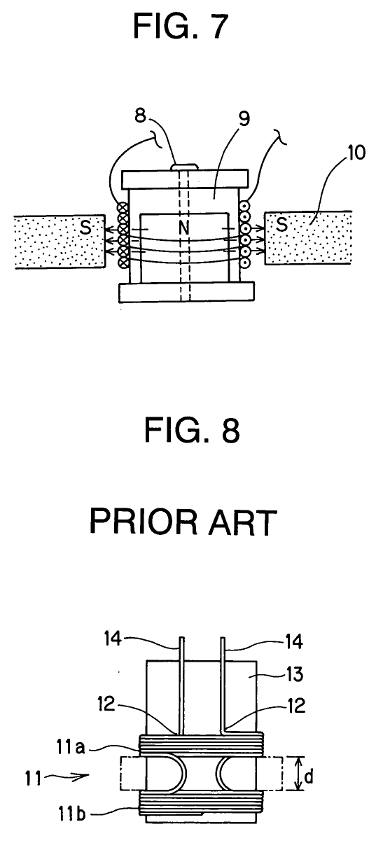

An acceleration test was conducted on each of the test pieces. FIG. 6 is a circuit diagram of a tester used in the examples of the invention, and FIG. 7 is a conceptual diagram showing the coil. An acceleration tester 6 has a temperature indicator 6a indicating the temperature of a coil, and a slide transformer (AC 100V) 7 is attached to the tester.

Each of the test pieces was assembled in a magnetic circuit, and fixed by a fixing member 8 so as not to be vibrated in the upward or downward direction. An application voltage was gradually increased by the slide transformer 7, and the temperature of the coil whose rising part is broken down was examined.

As a result, in the test piece 1 of the invention, no breaking down occurs in the rising part and anywhere even when the application voltage was increased until the temperature of the coil became 180° C. Breaking down occurs at 180° C., and the entire coil 1 was burnt and charred, and the position of the breaking down could not be specified. The test piece 2 of the invention was broken down at the temperature of 200° C. The test piece 3 of the invention was broken down at the temperature of 320° C. The test piece 4 of the invention was broken down at the temperature 360° C. In the case where “r” is equal to or larger than that of the test piece 4 of the invention, for example, when r=( 5/1)R, ( 10/1)R or the like, the temperature of occurrence of breaking down is not below that of the test piece 4 of the invention. It is understood from the above that occurrence of breaking down in the invention is suppressed.

On the other hand, the test piece 1 for comparison was broken down at the temperature of 80° C., and the rising part was burnt and charred. A crack occurs in the curved portion of the rising part, and it is estimated that the breaking down occurred at the crack. It is understood from the above that when “r” is less than (½)·R, the rising part of the coil is easily damaged.

It should be understood that various alternatives to the embodiments of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2004-58695 filed on Mar. 3, 2004 including the specification, claims, drawings and abstract is incorporated herein by reference in its entirety.

1. A structure of a rising part of a coil,
wherein at the time of rising an electric wire obtained by covering a conductor whose sectional shape is a square with an insulating film from a coil in which the electric wire is wound, and turning the electric wire in a desired direction, said electric wire is formed in a curve so that the inside of the curve is along the circumference of a circle having a radius “r” until said electric wire risen from said coil is turned in said desired direction, and said radius “r” has a length which is equal to or larger than ½ of one side of the square as the sectional shape of said conductor.

2. A structure of a rising part of a coil,
wherein at the time of rising an electric wire obtained by covering a conductor whose sectional shape is a rectangle with an insulating film from a coil in which the electric wire is wound, and turning the electric wire in a desired direction, said conductor has a rectangular shape in cross section, having a length which is longer than the length of another side orthogonal to said one side and is equal to or less than 1.5 times of the length of another side, said electric wire is formed in a curve so that the inside of the curve is along the circumference of a circle having a radius “r” until said electric wire risen from said coil is turned in said desired direction, and said radius “r” has a length which is equal to or larger than ½ of said another side of the rectangle as the sectional shape of said conductor.
